(19) United States
(12) Patent Application Publication
(10) Pub. No.: US 2007/0152517 A1
(43) Pub. Date: Jul. 5, 2007

(54) LINEAR MOTOR AND LINEAR COMPRESSOR USING THE SAME

(75) Inventors: Kyeong Bae PARK, Seoul (KR); Eon Pyo HONG, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/565,018

(22) Filed: Nov. 30, 2006

(30) Foreign Application Priority Data
Nov. 30, 2005 (KR) 10-2005-0115686

(51) Int. Cl. H02K 41/00; H02K 35/00

(52) U.S. Cl. 310/15; 310/12; 417/417; 92/169.1

(57) ABSTRACT

A linear motor and a linear compressor using the linear motor are provided. Since an inner core is linearly and reciprocally moved together with a target movement body and a magnet insertion recess is formed on an outer circumferential surface thereof, the forward/backward vibration movement of a magnet can be effectively controlled. In addition, since a gap is minimized, self-resistance that interferes with a force exerted by the magnet can be minimized, and accordingly, the size of the magnet necessary for outputting the same force can be minimized.

The present disclosure relates to subject matter contained in priority Korean Application No. 2005-115686, filed on Nov. 30, 2005, the disclosure of which is herein expressly incorporated by reference in its entirety.

### BACKGROUND OF THE INVENTION

1. Field of the Invention

The present invention relates to a linear motor and a linear compressor using the same. More particularly, the present invention is related to a linear motor in which an inner core is installed so as to be linearly moved together with a target movement body and a magnet is installed in a magnet insertion recess formed on an outer circumferential surface of the inner core. Additionally, the present invention is related and directed to a linear compressor using the above-noted linear motor.

2. Description of the Related Art

In general, a linear motor generates linear and reciprocal movement force for a linear and reciprocal movement target (referred to hereinafter as ‘target movement body’) such as a piston, which linear motor includes a stator having a coil installed therein and an actuator for linearly and reciprocally moving the target movement body by interacting with the stator.

Recently, a linear compressor for compressing a fluid such as a refrigerant gas by use of the linear motor has been developed.

The stator includes a bobbin, a coil wound inside the bobbin, an outer core radially installed about the bobbin, and an inner core separately installed at an inner side of the stator.

The actuator is a magnet linearly and reciprocally moved between the outer core and the inner core according to its interaction with a magnetic force generated when a current is applied to the coil.

The magnet has an outer gap between the magnet and an inner circumferential surface of the outer core and an inner gap between the magnet and an outer circumferential surface of the inner core, so that the magnet can be linearly and reciprocally moved between the outer core and the inner core.

The force (an output) of the linear motor is determined by a motor force constant (α) and a current (i) applied to the coil. Since the motor force constant (α) is proportional to a magnetic flux density (Bm) in the gap according to the magnet, the higher the magnetic flux density (Bm) in the gap by the magnet, the better efficiency can be obtained.

Herein, the magnetic flux density (Bm) in the gap is increased as the outer gap and the inner gap are reduced in accordance with the following relationship (1):

$$B m = \frac{B r x t}{2 ( g 1 + g 2 + t )} \qquad ( 1 )$$

wherein ‘Br’ is the magnetic flux density (an inherent quality) of the magnet, ‘t’ is the thickness of the magnet, ‘g1’ is the outer gap, and ‘g2’ is the inner gap. Thus, 2(g1+g2+t) is the gap of the linear motor.

Namely, the smaller the gap of the linear motor, the stronger is the force (output) of the linear motor.

However, the related art linear motor has a problem that since the gap is present at the inner side of the magnet as well as at the outer side thereof, the self-resistance that interferes with the force generated by the magnet is increased, and the usage amount (i.e., size) of the magnet must be increased to improve its output. In addition, since the inner gap as well as the outer gap must be managed to obtain the stable motor performance, productivity deteriorates.

Meanwhile, in an effort to minimize the gap, the inner core can be installed so as to be moved together with the piston and the magnet can be attached on the outer circumferential surface of the inner core. Then, because the inner gap (g2) between the magnet and the inner core is eliminated, the efficiency can be enhanced. However, in this case, a structure for attaching the magnet onto the inner core is additionally required, and it is difficult to effectively control the forward/backward vibration movement of the magnet.

### SUMMARY OF THE INVENTION

The present invention is designed to solve such a problem of the related art. Therefore, one object of the present invention is to provide a linear motor capable of effectively controlling a forward/backward vibration movement of a magnet by installing the magnet in an inner core, and thus is capable of reducing the size of the magnet or of enhancing the output of the magnet because a gap can be accordingly reduced by an amount as much as the thickness of the magnet, and to provide a linear compressor using the linear motor.

Another object of the present invention is to provide a linear motor capable of reducing saturation possibility of an inner core due to self-circulation flux by minimizing the self-circulation flux at both ends of a magnet, and a linear compressor using the linear motor.

To achieve the above objects, there is provided a linear motor comprising: a bobbin; a coil wound within the bobbin; an outer core provided at the bobbin; an inner core configured to be linearly and reciprocally moved together with a target movement body and including a magnet insertion recess provided on its outer circumferential surface; and a magnet installed in the magnet insertion recess.

The magnet insertion recess is configured to have a cylindrical shape along the outer circumferential surface of the inner core.

A length of the magnet insertion recess is configured to be larger than a length of the magnet.

The magnet insertion recess extends to a position beyond the poles of the outer core when the magnet is at stroke extremities.

The magnet insertion recess extends to an end of the inner core.

The linear motor additionally comprises a core frame coupled with the piston, the inner core being provided on the core frame.

In the linear motor, the elements are arranged from the central portion in the following order, starting from the target movement body, the core frame, an assembly of the inner core and the magnet, and an assembly of the outer core, the bobbin and the coil.

To achieve the above objects, there is also provided a linear compressor comprising: cylinder; a piston positioned to be linearly and reciprocally moved into and out of the cylinder; a bobbin; a coil wound within the bobbin; and an outer core provided at the bobbin. An inner core is configured to be linearly and reciprocally moved together with the piston and includes a magnet insertion recess provided on an outer circumferential surface of the inner core; and a magnet installed in the magnet insertion recess.

The magnet insertion recess is configured to have a cylindrical shape along the outer circumferential surface of the inner core.

The magnet insertion recess is configured to have a length larger than a length of the magnet.

The magnet insertion recess extends to a position beyond the poles of the outer core when the magnet is at stroke extremities.

The magnet insertion recess extends to each end of the poles of the inner core.

The linear compressor further includes a core frame coupled with the piston, the inner core being provided on the core frame.

To achieve the above objects, there is also provided a linear compressor comprising: a cylinder; a piston positioned to be linearly and reciprocally moved into and out of the cylinder and having a fluid path allowing a fluid to pass therethrough and a suction valve provided at a front portion of the piston to open and close the fluid path of the piston. A bobbin; a coil wound within the bobbin; an outer core provided at the bobbin; an inner core configured to be linearly and reciprocally moved together with the piston and including a magnet insertion recess provided on an outer circumferential surface of the inner core; a magnet installed in the magnet insertion recess; a cylinder block provided outside the cylinder and positioned at a front portion of the outer core; an outer cover provided at a rear portion of the outer core; a back cover fastened at the outer cover and having a fluid suction opening; a spring supporter installed at a rear portion of the piston and including a first spring interposed between the spring supporter and the outer cover and a second spring interposed between the spring supporter and the back cover; and a discharge valve assembly provided at the cylinder block to form a compression chamber inside the cylinder, the discharge valve assembly opening and closing the front portion of the cylinder according to an internal pressure of the compression chamber.

The magnet insertion recess is configured to have a cylindrical shape along the outer circumferential surface of the inner core.

The magnet insertion recess is configured to have a length larger than a length of the magnet.

The magnet insertion recess extends to a position beyond the poles of the outer core when the magnet is at stroke extremities,

The magnet insertion recess extends to each end of the poles of the inner core.

The linear compressor additionally comprises a core frame coupled with the piston, the inner core being provided at the core frame.

In the linear compressor, the elements are arranged from the central portion outwardly in the following order, the piston, the cylinder, the core frame, the assembly of the inner core and the magnet, and an assembly of the outer core, the bobbin and the coil.

The linear motor and the linear compressor using the linear motor constructed as described above in accordance with the present invention have the following advantages.

Since the inner core is installed to be linearly and reciprocally moved together with the target movement body, the magnet insertion recess is formed on the outer circumferential surface of the inner core and the magnet is installed in the magnet insertion recess, the forward/backward vibration movement of the magnet can be effectively controlled. In addition, since the gap is minimized, the self-resistance that interferes with the force exerted by the magnet can be minimized and thus the size of the magnet can be minimized.

In addition, since the magnet insertion recess of the inner core is made larger than the magnet and further extends beyond the poles of the outer core when the magnet is at stroke extremities, when the magnet is positioned at the extremities, the gap is increased according to the extension (i.e., size) of recess, thus increasing the self-resistance. Thus, the amount of the self-circulation flux at an end portion of the magnet can be reduced, and accordingly, saturation of the inner core according to concentration of the self-circulation flux can be prevented and reduction of a motor force constant and reduction of efficiency that may be generated when the self-circulation flux is strong can be also prevented.

Moreover, since the magnet insertion recess of the inner core extends to the pole of the inner core so as to be larger than the magnet, even when the stroke is controlled to be increased, the amount of self-circulation flux can be minimized. That is, the stroke can be easily controlled.

The foregoing and other objects, features, aspects and advantages of the present invention will become more apparent from the following detailed description of the preferred (non-limiting) embodiments of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, non-limitingly illustrate embodiments of the invention and together with the description serve to explain the principles of the invention.

In the drawings:

FIG. 1 is a partial vertical sectional view of a linear motor in accordance with a first embodiment of the present invention.

FIG. 2 is a view of a graph showing a comparison between electromagnetism of the linear motor in accordance with the present invention and that of a case where a magnet is protrudingly installed on an outer circumferential surface of an inner core.

FIG. 3 is a partial sectional view of a linear compressor employing the linear motor in accordance with the first embodiment of the present invention.

FIG. 4 is a partial vertical sectional view showing a case where a target movement body is protruded to the maximum extent in the linear motor in accordance with a second embodiment of the present invention.

FIG. 5 is a partial vertical sectional view showing a case where the target movement body is retracted to the maximum extent in the linear motor in accordance with the second embodiment of the present invention.

FIG. 6 is a partial vertical sectional view showing a case when the target movement body is protruded to the maximum extent in the linear motor in accordance with a third embodiment of the present invention.

FIG. 7 is a partial vertical sectional view showing a case where the target movement body is retracted to the maximum extent in the linear motor in accordance with the third embodiment of the present invention.

### DETAILED DESCRIPTION OF THE PREFERRED EMBODIMENT

The present invention is further described in the detailed description which follows, by reference to the noted plurality of drawings by way of non-limiting examples of preferred embodiments of the present invention, in which like reference numerals represent similar parts throughout the several views of the drawings.

The preferred embodiments of the present invention will now be described with reference to the accompanying drawings.

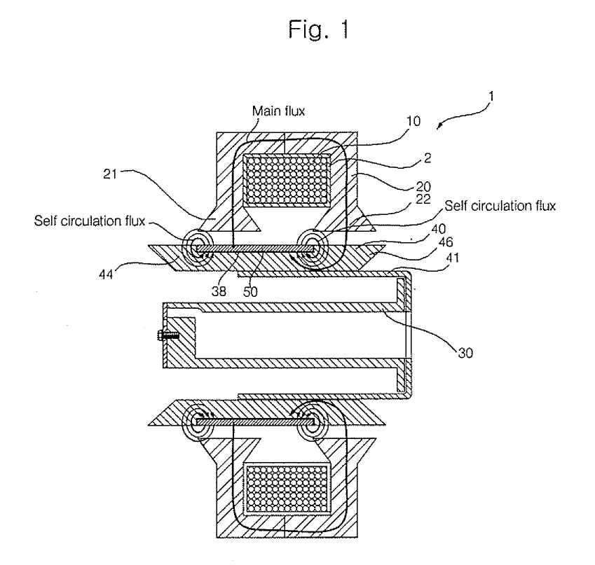

FIG. 1 is a partial vertical sectional view of a linear motor in accordance with a first embodiment of the present invention.

As shown in FIG. 1, the linear motor in accordance with the first embodiment of the present invention includes a bobbin 2, coil 10 wound inside or within the bobbin 2, an outer core 20 installed at or about the bobbin 2, an inner core 40 installed to linearly and reciprocally move a target movement body 30 such as a piston and having a magnet insertion recess 38 formed on its outer circumferential surface, and a magnet 50 insertedly installed in the magnet insertion recess 38.

The bobbin 2 has a generally cylindrical shape and its outer circumferential surface is exposed.

The coil 10 is wound inside the bobbin 2.

The outer core 20 provides for passage of magnetic flux therethrough when an AC current flows to and through the coil 10. A plurality of outer cores 20 are separately, radially disposed at the bobbin 2 in a circumferential direction.

The outer core 20 is formed so as to cover a portion of the bobbin 2, and front and rear poles 21 and 22 are separately formed on its inner circumference.

The target movement body 30 can be a piston or a rod that is linearly and reciprocally moved, without being limited in its type. In the present invention, the target movement body 30 is non-limitingly shown to be the piston for purposes of description.

The inner core 40, in which an iron core is radially stacked, provides for passage of magnetic flux together with the outer core 20.

The inner core 40 can be directly coupled with the piston 30 to transfer linear reciprocal movement force of the magnet 50 directly to the piston 30, or can be installed at a core frame 41 coupled with the piston 30 to transfer the linear reciprocal movement force to the piston 30 via the core frame 41. In the present invention, the inner core 40 is non-limitingly described and illustrated as being installed on the outer circumferential surface of the core frame 41.

The inner core 40 can be attached on the outer circumferential surface of the core frame 41 in any desired fashion such as by an adhesive, or fastened by any desired fastening member (or members) such as a screw. Alternatively, as a matter of course, the inner core 40 can be installed to be caught or retained in position by any other mechanism, such as by a protrusion or by a recess.

The inner core 40 has a, for example, hollow cylindrical shape and includes a front pole 44 formed at its front end portion and a rear pole 46 formed at a rear end portion thereof.

Referring to the inner core 40, if the overall length of the inner core 40 is smaller than the sum of the length of the outer core 20 and the stroke of the target movement body 30, when the inner core 40 and the magnet 50 are moved, reluctance force, namely, a reverse force, that acts in a direction such that a gap between the inner core 40 and the outer core 20 is minimized, namely, in a direction opposite a direction in which the magnet 50 is moved, is increased. Thus, the overall length of the inner core 40 is made greater than the sum of the length of the outer core 20 and the stroke of the target movement body 30.

As for the inner core 40, the magnet insertion recess 38 is formed along the outer circumferential surface of the inner core 40, has a generally cylindrical shape, and has a length that is the same as or slightly greater than that of the magnet 50.

The magnet 50 is magnetized in the circumferential direction, and when the direction of the magnetic flux passing through the outer core 20 and the inner core 40 is changed according to the direction of the AC current flowing at the coil 10, the magnet 50 receives force for a forward/backward linear and reciprocal movement according to Fleming's left hand rule and the force is transferred to the target movement body 30 through the inner core 40 and the core frame 41.

The magnet 50 can be directly secured to the inner core by, for example, being adhered in the magnet insertion recess 38 of the inner core 40 by using an adhesive, or a carbon film can be taped on the magnet 50 positioned in the magnet insertion recess 38, which is then hardened at a high temperature for about one hour to make the magnet 50 adhere in the magnet insertion recess 38. Of course, other adhering, securing or fastening mechanisms or devices can also be used to retain the magnet within the recess.

The magnet 50 can be wholly inserted in the magnet insertion recess 38 or only a portion of the magnet 50 can be inserted in the magnet insertion recess 38 while the other remaining portion thereof can protrude out from the outer circumferential surface of the inner core. In this case, in order to minimize the gap, preferably, the magnet 50 is wholly inserted in the magnet insertion recess 38.

In the linear motor, the elements are arranged from the central portion outwardly, starting from the piston 30, the core frame 41, the assembly of the inner core 40 and the magnet 50, and the assembly of the outer core 20, the bobbin 2 and the coil 10.

The operation of the linear motor constructed as described above will be described as follows.

First, when an AC current is applied to the coil 10, the direction of magnetic flux is changed and flows in the outer core 20 and the inner core 40, according to which force for a forward/backward linear and reciprocal movement is generated by the magnet 50.

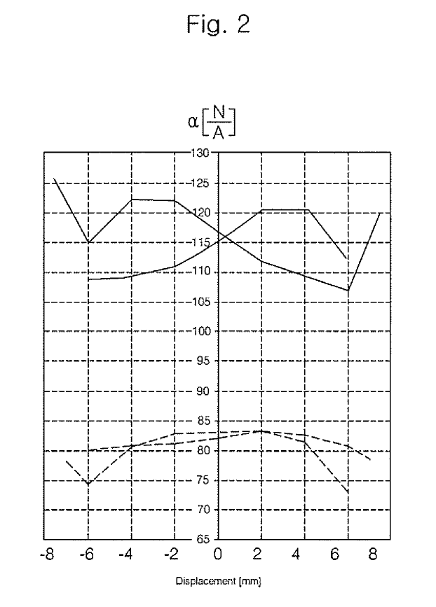

FIG. 2 is a view showing a comparison between the electromagnetism of the linear motor in accordance with the present invention and that of a case where the magnet is protrudingly installed on an outer circumferential surface of an inner core.

With reference to FIG. 1, when the magnet 50 is protrudingly disposed on the outer circumferential surface of the inner core 40, without provision of the magnet insertion recess on the outer circumferential surface of the inner core 40, as shown in FIG. 2, electromagnetism (α) has the range of about 73˜84 [N/A] as indicated by dotted lines in the graph. However, in the case where the magnet insertion recess 38 is formed on the outer circumferential surface of the inner core 40, and the magnet 50 is positioned therein without protruding from the outer circumferential surface of the inner core 40, the electromagnetism (α) has the range of about 107˜125 [N/A] as indicated by the solid lines in the graph

That is, when the magnet 50 is positioned within the magnet insertion recess 38 of the inner core 40, since the gap is minimized, the self-resistance that interferes with the force exerted by the magnet 50 can be minimized while the electromagnetism (α) can become relatively strong.

When the magnet 50 advances, it pushes the front side of the magnet insertion recess 38 of the inner core 40 forwardly, and when the magnet 50 retracts, the magnet 50 pushes the rear side of the magnet insertion recess 38 of the inner core backwardly. The inner core 40 is moved forward or backward together with the magnet 50.

The linear and reciprocal movement of the inner core 40 is transferred to the piston 30 through the core frame 41, and the magnet 50, the inner core 40 and the piston 30 are integrally moved linearly and reciprocally.

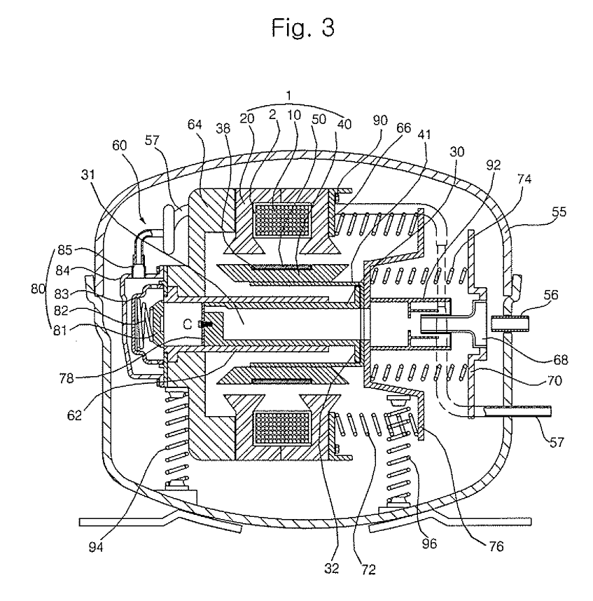

FIG. 3 is a partial sectional view of a linear compressor employing the linear motor in accordance with the first embodiment of the present invention.

In this embodiment of the present invention, as shown in FIG. 3, in the linear compressor, a fluid path 31 is formed to extend along a length of the piston 30 allowing a fluid such as a refrigerant gas to pass therethrough.

The linear compressor includes a shell 55 forming the exterior and a linear compressing part 60 installed inside the shell 55 such that it can be buffered therein and having a linear motor 1 and the piston 30.

A suction pipe 56 for sucking the fluid is penetratingly installed on the shell 55, and a loop pipe 57 for discharging a fluid which has been compressed in the linear compressing part 60 is also penetratingly installed on a different portion of the shell 55.

The linear compressing part 60 includes a cylinder 62 installed in which the piston 30 is linearly and reciprocally moved, a cylinder block 64 installed outside the cylinder 62 and disposed at a front side of the outer core 20, an outer cover 66 disposed at a rear side of the outer core 20, a back cover 70 fastened to the outer cover 66 and including a fluid suction hole 68, and a spring supporter 76 installed at a rear end side of the piston 30 and having a first spring 72 interposed between the spring supporter 76 and the outer cover 66 and a second spring 74 interposed between the spring supporter 76 and the back cover 70.

In the linear compressing part 60, the elements are disposed from the central portion sequentially outwardly, starting from the cylinder 62, the core frame 41, the assembly of the inner core 40 and the magnet 50, and the assembly of the outer core 20, the bobbin 2 and the coil 10.

A flange 32 is formed so as to protrude from a rear end of the piston 30 so as to be fastened to the core frame 41 and the spring supporter 76 by a fastening member such as a screw, or any other appropriate fastening or securing mechanism.

The linear compressing part 60 additionally includes a suction valve 78 installed at the front surface of the piston 30 so as to open and close the fluid path 31 of the piston 30, a compression chamber (C) installed in the piston 30 at the cylinder block 64 so as to be positioned at the opposite side of the piston 30 with respect to the fluid path 31, and a discharge valve assembly 80 for opening and closing the front side of the cylinder 62 according to an internal pressure of the compression chamber (C).

The suction valve 78 has a structure such that it is elastically bent to open and close the fluid path 31, and is fastened to the front surface or portion of the piston 30 by a screw or any other appropriate fastening mechanism.

The discharge valve assembly 80 includes a discharge valve 81 for opening and closing a front end of the cylinder 62, an inner discharge cover 83 on which a discharge spring 82 is installed to elastically support the discharge valve 81, an outer discharge cover 84 for forming a fluid path with the inner discharge cover 83, and a discharge pipe 85 installed at the outer discharge cover 84 and connected with the loop pipe 57.

In FIG. 3, reference numeral 90 denotes a fastening bolt for fastening the outer cover 66 and the cylinder block 64 by sequentially penetrating them, and reference numeral 92 denotes a muffler installed at a rear end side of the piston 30.

Reference numeral 94 denotes a front damper for elastically supporting the cylinder block 64 within the shell 55 and reference numeral 96 denotes a rear damper for elastically supporting the spring supporter 76 within the shell 55.

The linear compressor constructed as described above operates as follows.

First, when the piston 30 recedes (or retracts), it is resonated and amplified by the first and second springs 72 and 74 to generate a strong force, and at this time, the suction valve 78 opens the fluid path 31 according to a pressure difference between the compression chamber (C) and the fluid path 31 of the piston 30, and the fluid, such as the refrigerant gas, present inside the fluid path 31 is sucked into the compression chamber (C).

Meanwhile, when the piston 30 proceeds (or advances), it is resonated and amplified by the first and second springs 72 and 74 to generate a strong force, and at this time, the suction valve 78 closes the fluid path 31 of the piston by the fluid sucked into the compression chamber (C) and the self-elastic force. The fluid within the compression chamber (C) is pressed and compressed by the piston 30 and the suction valve 78 and then discharged through the discharge valve assembly 80 and the loop pipe 57.

At this time, the fluid inside the shell 55 passes through the fluid suction hole 68 of the back cover 70 and the muffler 92 and then is sucked into the fluid path 31 of the piston 30 by virtue of a negative pressure formed in the fluid path 31 of the piston 30.

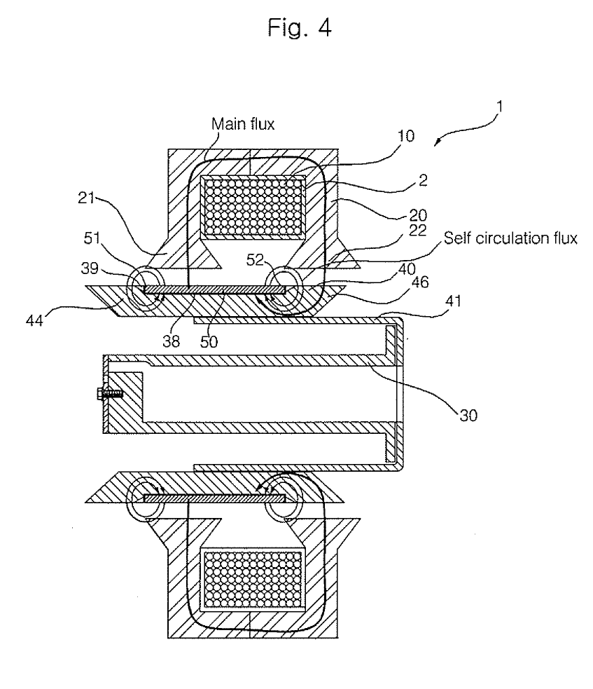

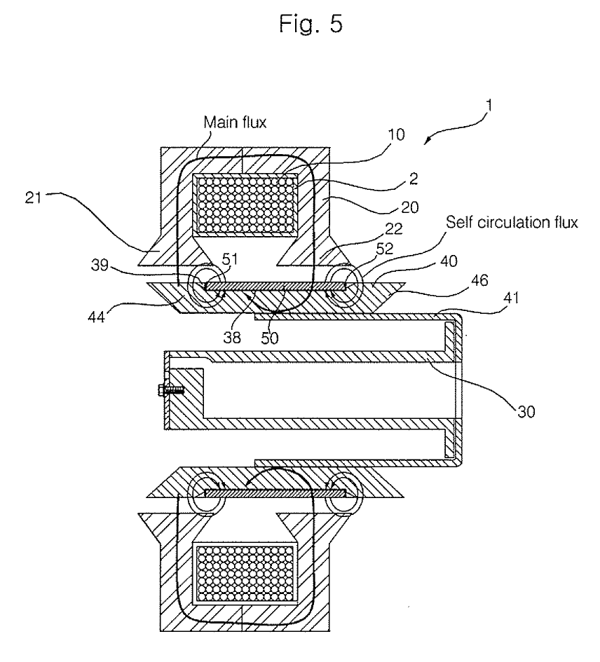

FIG. 4 is a partial vertical sectional view showing a case where a target movement body is advanced to the maximum extent in the linear motor in accordance with a second embodiment of the present invention, and FIG. 5 is a partial vertical sectional view showing a case where the target movement body is retracted to the maximum extent in the linear motor in accordance with the second embodiment of the present invention.

In this embodiment of the present invention as shown in FIGS. 4 and 5, in the linear motor, an entrance 39 of the magnet insertion recess 38 of the inner core 40 is formed to be greater than the magnet 50.

In the linear motor, the entrance 39 of the magnet insertion recess 38 is formed to be larger than the magnet 50, extending up to a position beyond the front and rear poles 21 and 22 of the outer core 20 when the magnet 50 has the maximum stroke (i.e., is at the extremities of the stroke).

Referring back to the linear motor in accordance with the first embodiment of the present invention as shown in FIG. 1, when the front end portion of the magnet 50 advances to be close to a front end of the front pole 21 of the outer core 20 or when the rear end portion of the magnet 50 retracts to be close to a rear end of the rear pole 22 of the outer core 20, the self-circulation flux is increased to reduce the motor force constant, deteriorating the efficiency, and because the self-circulation flux is concentrated at the front end portion or the rear end portion of the magnet 50, the peripheral portion of the front end portion and the peripheral portion of the rear end portion of the magnet 50 of the inner core 40 are easily saturated. In comparison, however, when the entrance (i.e., the size) 39 of the magnet insertion recess 38 is formed to be larger than the magnet 50, a gap can be increased by the entrance 39, so the self-resistance can be increased.

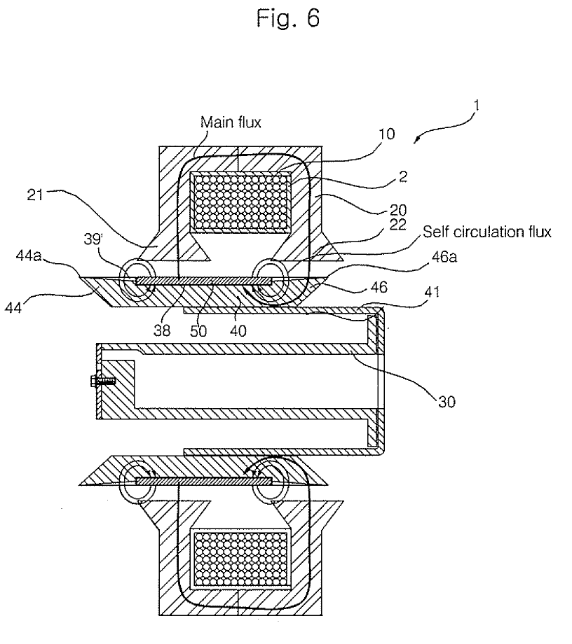

That is, as shown in FIGS. 5 and 6, the amount of self-circulation flux of the end portions 51 and 52 of the magnet 50 can be reduced compared with the linear motor of the first embodiment of the present invention.

Meanwhile, as the self-circulation flux is reduced, the size of the main flux of the outer core 20 having the relatively small self-resistance is increased.

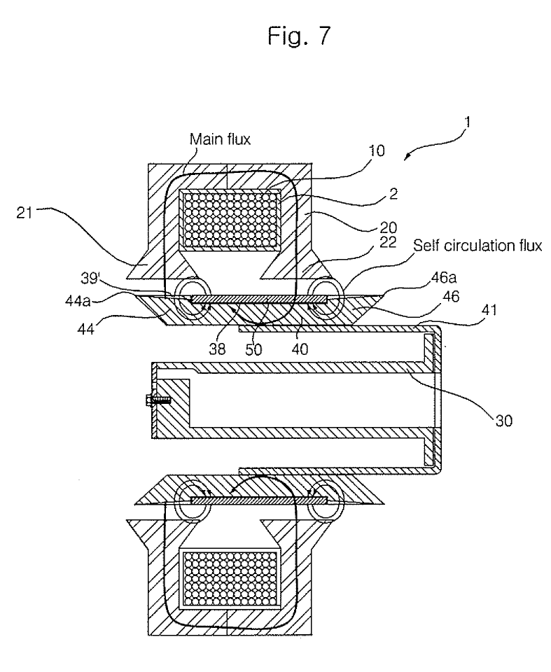

FIG. 6 is a partial vertical sectional view showing a case when the target movement body is advanced to the maximum extent in the linear motor in accordance with a third embodiment of the present invention, and FIG. 7 is a partial vertical sectional view showing a case where the target movement body is retracted to the maximum extent in the linear motor in accordance with the third embodiment of the present invention.

In this embodiment of the present invention, as shown in FIGS. 6 and 7, an entrance 39′ of the magnet insertion recess 38 of the inner core 40 is formed extending up to ends 44a and 46a of the front and rear poles 44 and 46. That is, the entrance 39′ of the third embodiment of the present invention is larger than that of the linear motor of the second embodiment of the present invention, so even if a stroke is great, a gap and an increase in a self-resistance and a corresponding self-circulation flux can be minimized by the entrance 39′.

As stated above, the linear motor and the linear compressor using the linear motor in accordance with the present invention have the many advantage as follows.

In particular, since the inner core is installed to be linearly and reciprocally moved together with the target movement body and the magnet insertion recess is formed on the outer circumferential surface thereof, the forward/backward vibration movement of the magnet can be effectively controlled. In addition, since the gap is minimized, the self-resistance that interferes with the force exerted by the magnet can be minimized, and accordingly, the amount (i.e., size) of the magnet that is necessary for outputting the same force can be minimized.

In addition, the entrance (i.e., the ends) of the magnet insertion recess of the inner core is extendedly formed to be larger than the magnet such that it extends to a position beyond the poles of the outer core when the magnet has the maximum stroke. Accordingly, when the magnet is positioned at both side ends, the gap can be increased by the extended entrance, increasing the self-resistance, and accordingly, saturation of the inner core according to concentration of the self-circulation flux can be prevented and the reduction of the motor force constant, which is generated when the self-circulation flux is strong, and reduction of the efficiency can be also reduced.

Moreover, since the entrance of the magnet insertion recess of the inner core is formed extending up to the poles of the inner core so as to be larger than the magnet, even when the stroke is increased, the amount of the self-circulation flux can be minimized and thus the stroke can be easily controlled.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

Although the invention has been described with reference to exemplary embodiments, it is understood that the words that have been used are words of description and illustration, rather than words of limitation. Changes may be made, within the purview of the appended claims, as presently stated and as amended, without departing from the scope and spirit of the present invention in any of its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

What is claimed is:

1. A linear motor comprising:
a bobbin;
coil wound within the bobbin;
an outer core provided at the bobbin;
an inner core configured to be linearly and reciprocally moved together with a target movement body and including a magnet insertion recess provided on an outer circumferential surface of the inner core; and
a magnet installed in the magnet insertion recess.

2. The motor of claim 1, wherein the magnet insertion recess is configured to have a cylindrical shape along the outer circumferential surface of the inner core.

3. The motor of claim 1, wherein a length of the magnet insertion recess is configured to be larger than a length of the magnet.

4. The motor of claim 3, wherein the magnet insertion recess extends to a position beyond the poles of the outer core when the magnet is at stroke extremities.

5. The motor of claim 3, wherein the magnet insertion recess extends to each end of the poles of the inner core.

6. The motor of claim 1, further comprising:
a core frame coupled with the piston, the inner core being provided on the core frame.

7. The motor of claim 6, wherein the elements are arranged from the central portion outwardly in the following order, starting from the target movement body, the core frame, the assembly of the inner core and the magnet, and the assembly of the outer core, the bobbin and the coil.

8. A linear compressor comprising:
cylinder;
a piston positioned to be linearly and reciprocally moved into and out of the cylinder;
a bobbin;
coil wound within the bobbin;
an outer core provided at the bobbin;
an inner core configured to be linearly and reciprocally moved together with the piston and including a magnet insertion recess provided on an outer circumferential surface of the inner core; and
a magnet installed in the magnet insertion recess.

9. The compressor of claim 8, wherein the magnet insertion recess is configured to have a cylindrical shape along the outer circumferential surface of the inner core.

10. The compressor of claim 8, wherein the magnet insertion recess is configured to have a length larger than a length of the magnet.

11. The compressor of claim 8, wherein the magnet insertion recess extends to a position beyond the poles of the outer core when the magnet is at stroke extremities.

12. The compressor of claim 10, wherein the magnet insertion recess extends to each end of the poles of the inner core.

13. The compressor of claim 8, wherein the linear motor further comprises a core frame coupled with the piston, the inner core being provided on the core frame.

14. A linear compressor comprising:
a cylinder;
a piston positioned to be linearly and reciprocally moved into and out of the cylinder and having a fluid path allowing a fluid to pass therethrough;
a suction valve provided at a front portion of the piston to open and close the fluid path of the piston;
a bobbin;
coil wound within the bobbin;
an outer core provided at the bobbin;
an inner core provided to be linearly and reciprocally moved together with the piston and comprising a magnet insertion recess provided on an outer circumferential surface of the inner core;
a magnet installed in the magnet insertion recess;
a cylinder block provided outside the cylinder and positioned at a front portion of the outer core;
an outer cover provided at a rear portion of the outer core;
a back cover fastened to the outer cover and having a fluid suction opening;
a spring supporter provided at a rear portion of the piston and comprising a first spring interposed between the spring supporter and the outer cover and a second spring interposed between the spring supporter and the back cover; and
a discharge valve assembly provided at the cylinder block to form a compression chamber inside the cylinder, the discharge valve assembly opening and closing the front portion of the cylinder according to an internal pressure of the compression chamber.

15. The compressor of claim 14, wherein the magnet insertion recess is configured to have a cylindrical shape along the outer circumferential surface of the inner core.

16. The compressor of claim 14, wherein the magnet insertion recess is configured to have a length larger than a length of the magnet.

17. The compressor of claim 16, wherein the magnet insertion recess extends to a position beyond poles of the outer core when the magnet is at stroke extremities.

18. The compressor of claim 16, wherein the magnet insertion recess extends to each end of the poles of the inner core.

19. The compressor of claim 14, wherein further comprising:
a core frame coupled with the piston, the inner core being provided on the core frame.

20. The compressor of claim 19, wherein the elements are arranged from the central portion outwardly in the following order, the piston, the cylinder, the core frame, the assembly of the inner core and the magnet, and the assembly of the outer core, the bobbin and the coil.
